(19) United States
(12) Patent Application Publication
(10) Pub. No.: US 2009/0143978 A1
(43) Pub. Date: Jun. 4, 2009

(54) PORTABLE ELECTRONIC DEVICE AND TRAVEL TIME FORECAST METHOD

(75) Inventors: Shih-Fang Wong, Tu-Cheng (TW); Yi-Feng Weng, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY( Shenzhen) Co., LTD, Shenzhen City (TW); HON HAI PRECISION INDUSTRY CO., LTD., Tu-Cheng (TW)

(21) Appl. No.: 12/195,413

(22) Filed: Aug. 20, 2008

(30) Foreign Application Priority Data
Nov. 30, 2007 (CN) 200710202807.3

(51) Int. Cl. G01C 21/00

(52) U.S. Cl. 701/201

(57) ABSTRACT

A portable electronic device for mapping and displaying route information includes a route generator, a length calculator, a travel time calculator, and a display system. The route generator is configured for generating a route between a starting location and a destination based on predetermined mapping data. The length calculator is configured for determining a length of the route based on the predetermined mapping data. The travel time calculator is configured for determining a travel time based on a speed of the portable electronic device and the length. The display system is configured for displaying the route and the travel time for guiding a user to the destination. A related travel time forecast method is also provided.

### BACKGROUND

1. Field of the Invention

Embodiments of the present disclosure relate to portable electronic devices, and more particularly to a portable electronic device comprising a navigation function.

2. Description of related art

Portable electronic devices, such as mobile phones, handheld game consoles, personal digital assistants, etc. are commonly used. Some of these portable electronic devices (e.g., high-end products) have a positioning capability and navigation functions. These portable electronic devices may search for an optimized route between a starting location and a destination point using mapping data. When a route including destination information is requested, a current location of the portable electronic device is determined according to the global positioning system (GPS) signals. Then, an optimized route to the destination is selected according to the starting location and destination point of the mapping data. Finally, navigational information may be visually provided through a display screen of the portable electronic device. The navigational information may include optimized route to the destination, the length of the optimized route, etc. However, a travel time that a user who takes the portable electronic device should spend in gong to the destination is not provided. This is inconvenient for a user to arrange his/her schedule properly.

Therefore, a portable electronic device that can provide travel time information is needed to address the aforementioned deficiency and inadequacies.

### SUMMARY

A portable electronic device for mapping and displaying route information includes a route generator, a length calculator, a travel time calculator, and a display system. The route generator is configured for generating a route between a starting location and a destination based on predetermined mapping data. The length calculator is configured for determining a length of the route based on the predetermined mapping data. The travel time calculator is configured for determining a travel time based on a speed of the portable electronic device and the length. The display system is configured for displaying the route and the travel time for guiding a user to the destination. A related travel time forecast method is also provided.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic block diagram of a portable electronic device in accordance with the present disclosure.

FIG. 2 is a schematic block diagram of a central processing module of FIG. 1.

FIG. 3 is a flowchart of a travel time forecast method in accordance with one embodiment of the present disclosure.

### DETAILED DESCRIPTION OF CERTAIN INVENTIVE EMBODIMENTS

References will now be made to the drawings to describe certain inventive embodiments of the present disclosure.

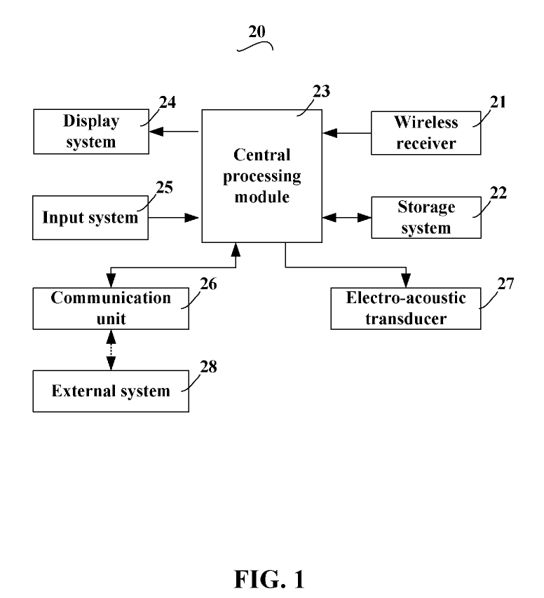

Referring to FIG. 1, a portable electronic device 20 includes a wireless receiver 21, a storage system 22, a central processing module 23, a display system 24, an input system 25, a communication unit 26, and an electro-acoustic transducer 27. The portable electronic device 22 provides an optimized route to a determined destination, a length of the route, and an estimated travel time to the destination. The central processing module 23 is connected to the other components, and configured for controlling operations of the portable electronic device 20.

The wireless receiver 21 is configured for receiving positioning signals. The positioning signals may be supplied by a global positioning system (GPS), a radio frequency triangulation system, global navigation satellite systems (GNSS), or a long range navigation system (LORANC), or other similar positioning systems.

The storage system 22 is configured for storing mapping data of digitalized maps. The input system 25 is configured for receiving inputs, such as a route request input, and an estimated speed of a user taking the portable electric device 20. The input system 25 may be a keyboard, a touch screen, or a handwriting input module (such as a drawing tablet or a tablet-PC).

The communication unit 26 is configured for communicating with an external system 28 to update the mapping data stored in the storage system 22. The external system 28 could be a wireless or wired network including a map database.

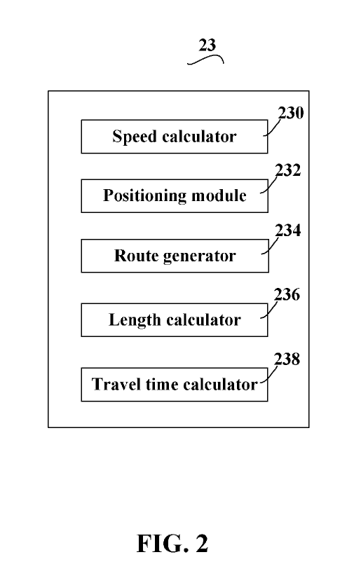

Referring also to FIG. 2, the central processing module 23 includes a speed calculator 230, a positioning module 232, a route generator 234, a length calculator 236, and a travel time calculator 238.

The positioning module 232 is configured for analyzing positioning signals received through the wireless receiver 21, and determining a current position of the portable electronic device 20 based on the positioning signals. It may be understood that information of the current position of the portable electronic device 20 includes longitude and latitude values.

The route generator 234 is configured for selecting/generating an optimized route according to a starting location and a destination of the mapping data in response to the route request received via the input system 25. The route request may include information of the starting location and the destination. In one embodiment, the route request may only include information about the destination. In this embodiment, the starting location may be defaulted to a current position of the portable electronic device 20.

The length calculator 236 is configured for determining/measuring a length of the optimized route based on the mapping data. The length of the optimized route is referred to as travel length hereinafter.

The travel time calculator 238 is configured for determining an estimated travel time from the starting location to the destination by dividing the travel length by a speed of the portable electronic device 20. The speed of the portable electronic device 20 may be an estimated speed that is inputted via the input system 25 by the user. The speed of the portable electronic device 20 may also be an average moving speed (referred to as a current speed hereinafter) determined by the speed calculator 230.

The speed calculator 230 is configured for determining a current speed of the portable electronic device 20. One method for determining the current speed is to measure a time interval needed for the portable electronic device 20 to move a predetermined length, and divide the predetermined length by the time interval. Another method for determining the current speed is to measure a length the portable electronic device 20 moves within a predetermined time period, and then divide the measured length by the predetermined time period. Understandly, the length the portable electronic device 20 moves is measured by the length calculator 236 with respect to the positioning module 232 based on the mapping data and the positioning signals. In one exemplary embodiment, the portable electronic device 20 determines the current speed using the former method.

The display system 24 is configured for displaying the requested route and the estimated travel time of the route. The display system 24 may further display the travel length, the current position, the current speed of the portable electronic device 20, and other navigation information according to user options to more clearly show the requested route to the destination. The electro-acoustic transducer 27 is configured for outputting the navigation information, such as the travel time, in the form of audible sound. In one exemplary embodiment, the electro-acoustic transducer 27 is a speaker.

In operation, the positioning module 232 generates the current position of the portable electronic device 20 in real time based on positioning signals when the portable electronic device 20 receives the route request including the destination via the input system 25. The route generator 234 generates an optimized route from the current position to the destination based on the mapping data. The length calculator 236 determines the length of the optimized route (namely, the travel length) based on the mapping data. The display system 24 displays at least one of following navigation information: the optimized route, the travel length, and the current position of the portable electronic device 20.

Meanwhile, the central processing module 23 starts timing, and the length calculator 236 determines a reference point on the optimized route based on the mapping data. The length of the route from the current position to the point equals to a predetermined length. When the portable electronic device 20 (e.g, a vehicle comprising the user and the portable electronic device 20) reaches the reference point on the mapping data, the central processing module 23 stops timing and generates the time interval correspondingly. The speed calculator 230 determines the current speed by dividing the predetermined length by the time interval. The travel time calculator 238 determines the travel time by dividing the travel length by the current speed. Finally, the display system 24 displays the travel time and the current speed of the portable electronic device 20. In one exemplary embodiment, the electro-acoustic transducer 27 outputs the same information as displayed by the display system 24 in an audible sound.

Alternatively, when the portable electronic device 20 receives a route request including the destination and an estimated speed via the input system 25, the positioning module 232 generates a current position of the portable electronic device 20. The route generator 234 generates an optimized route from the current position to the destination. The length calculator 236 determines the travel length. The travel time calculator 238 determines the travel time by dividing the travel length by the inputted estimated speed. Finally, the display system 24 displays at least one of following navigation information: the optimized route, the travel length, the current position and estimated speed of the portable electronic device 20, and the travel time. The electro-acoustic transducer 27 outputs the travel time or all the same information as the displayed by the display system 24 in audible sound. In one exemplary embodiment, the requested route and the travel time is provided synchronously.

In one exemplary embodiment, the central processing module 23 may update a length of a route from an updated current position to a destination when moving towards the destination, and determine an updated current speed of the portable electronic device 20 according to the updated length. Thus, a user can get an updated travel time spent from the updated current position to the destination in time.

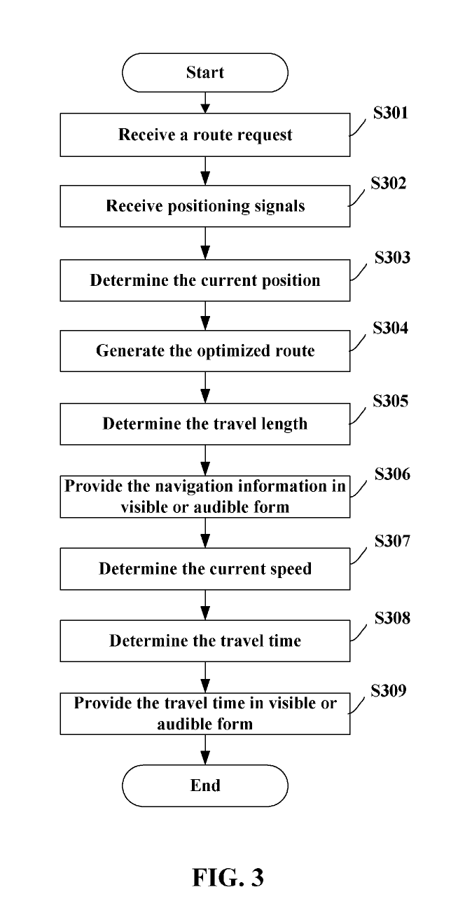

Referring to FIG. 3, in one exemplary embodiment, a travel time forecast method using the portable electronic device 20 includes the following blocks.

In block S301, the input system 25 of the portable electronic device 20 receives a route request including information about the destination.

In block S302, the wireless receiver 21 receives a plurality of positioning signals from a positioning system, such as a satellite system.

In block S303, the positioning module 232 analyzes the positioning signals, and determines the current position (namely, the starting location) of the portable electronic device 20 based on the positioning signals.

In block S304, the route generator 234 generates an optimized route from the current position to the destination based on the mapping data.

In block S305, the length calculator 236 determines the travel length of the optimized route based on the mapping data.

In block S306, the display system 24 displays at least one of following navigation information to provide navigation information: the optimized route, the travel length, the current position and estimated speed of the portable electronic device 20. The electro-acoustic transducer 27 may output all the same information as the display system 24 outputted in audible sound.

In block S307, the speed calculator 230 determines the current speed of the portable electronic device 20.

In block S308, the travel time calculator 238 determines the travel time by dividing the travel length by the current speed.

In block S309, the display system 24 displays the travel time. The electro-acoustic transducer 27 may output the travel time in audible sound.

It may be understood that block S307 may be omitted if a speed of the portable electronic device is included in the route request. It may be further understood that blocks S302 and S303 may be omitted if a starting location is included in the route request.

The portable electronic device 20 can provide a user an optimized route to a destination when a route request including a destination is entered. The portable electronic device 20 can further provide a travel length of the route, and an estimated travel time to the destination.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A portable electronic device for mapping and displaying route information, comprising:
a route generator configured for generating a route between a starting location and a destination based on predetermined mapping data;
a length calculator configured for determining a length of the route based on the predetermined mapping data;
a travel time calculator configured for determining a travel time based on a speed of the portable electronic device and the length of the route; and
a display system configured for displaying the route and the travel time.

2. The portable electronic device as claimed in claim 1, further comprising a storage system for storing the predetermined mapping data.

3. The portable electronic device as claimed in claim 2, further comprising an input system configured for receiving a route request comprising information about the destination.

4. The portable electronic device as claimed in claim 3, wherein the starting location is a current position of the portable electronic device.

5. The portable electronic device as claimed in claim 4, further comprising a wireless receiver configured for receiving positioning signals.

6. The portable electronic device as claimed in claim 5, further comprising a positioning module configured for generating information about the current position of the portable electronic device according to the positioning signals.

7. The portable electronic device as claimed in claim 5, wherein the positioning signals are supplied by one of a global positioning system, a radio frequency triangulation system, a global navigation satellite systems, and a long range navigation system.

8. The portable electronic device as claimed in claim 6, further comprising a central processing module, the central processing module comprising the route generator, the length calculator, the a travel time calculator, and the positioning module.

9. The portable electronic device as claimed in claim 8, wherein the central processing module further comprises a speed calculator for determining a current speed of the portable electronic device, the travel time is determined based on the current speed of the portable electronic device and the length of the route.

10. The portable electronic device as claimed in claim 1, further comprising an electro-acoustic transducer configured for outputting the travel time in the form of audible sound.

11. The portable electronic device as claimed in claim 1, further comprising a communication unit for communicating with an external system to update the predetermined mapping data.

12. A portable electronic device for mapping and displaying route information, comprising:
an input system configured for receiving information of a destination;
a wireless receiver configured for receiving positioning signals;
a central processing module configured for generating a route between a starting location and a destination based on mapping data when receiving a route request, determining a length of the route, and determining a travel time based on a speed of the portable electronic device and the length; and
a display system configured for displaying the route and the travel time for guiding a user to the destination.

13. The portable electronic device as claimed in claim 12, further comprising:
a storage system for storing the predetermined mapping data; and
an electro-acoustic transducer for outputting the travel time in the form of audible sound.

14. The portable electronic device as claimed in claim 12, wherein the starting location is the current position of the portable electronic device, the central processing module is further configured for generating information of the current position of the portable electronic device according to the positioning signals.

15. A travel time forecast method of a portable electronic device, comprising:
receiving a route request comprising information of a starting location and a destination;
generating a route between the starting location and the destination based on predetermined mapping data;
determining a length of the route based on the predetermined mapping data;
determining a travel time based on a speed of the portable electronic device and the length; and
displaying the route and the travel time for guiding a user to the destination.

16. The travel time forecast method of a portable electronic device as claimed in claim 15, wherein the starting location is the current position of the portable electronic device, and the current position of the portable electronic device is generated according to received positioning signals.

17. The travel time forecast method of a portable electronic device as claimed in claim 15, wherein the speed of the portable electronic device is inputted by a user.

18. The travel time forecast method of a portable electronic device as claimed in claim 15, wherein the speed of the portable electronic device is determined by measuring a time period needed for the portable electronic device to move a predetermined length based on predetermined mapping data and received positioning signals, and dividing the predetermined length by the time period.

19. The travel time forecast method of a portable electronic device as claimed in claim 15, wherein the travel time is further outputted in the form of audible sound.

20. The travel time forecast method of a portable electronic device as claimed in claim 15, further comprising updating the predetermined mapping data wirelessly.
